(19) United States
(12) Patent Application Publication
(10) Pub. No.: US 2024/0179454 A1
(43) Pub. Date: May 30, 2024

(54) Outdoor speaker

(71) Applicant: Yangjun Mai, Huizhou (CN)

(72) Inventor: Yangjun Mai, Huizhou (CN)

(21) Appl. No.: 18/071,099

(22) Filed: Nov. 29, 2022

(51) Int. Cl. H04R 1/28; H04R 1/02; H04R 1/30

(52) U.S. Cl. CPC H04R 1/2834; H04R 1/023; H04R 1/025; H04R 1/026; H04R 1/30

(57) ABSTRACT

An outdoor speaker includes a shell and a horn assembly in the shell, the shell has a first surface and a second surface opposite the first surface, the first surface and the second surface are arranged two sides of the horn assembly, a first mounting hole and a second mounting hole are provided thereon respectively; a first passive plate is mounted in the first mounting hole, and a second passive plate is mounted in the second mounting hole; a first protective shell covers the first surface and the first passive plate, a second protective shell covers the second surface and the second passive plate. The outdoor speaker has good bass effect, good sealing, rain and dust prevention, suitable for use outdoors.

### FIELD OF THE INVENTION

The present invention relates to the technical field of speaker, more particularly, to a kind of outdoor speaker.

### BACKGROUND OF THE INVENTION

As an improvement of living level, people pay more and more attention to move and exercise, especially, with the promotion of Chinese square dance, dancing with music outdoors has become an important way for people to relaxation and entertain themselves, therefore, people's demand for outdoor speakers is growing.

In the current outdoor speakers, the speaker systems can be roughly divided into cone loudspeakers and cuboid speakers of different sizes. These kinds of speaker systems are not suitable for playing soft music, or playing a very poor bass effect, which can not give people a good music enjoyment. In addition, both of the sealing nature and the rain-proof performance in the current outdoor speakers are poor, the current outdoor speakers are easy to short-circuit and not easy to carry for larger, heavy bodies.

### SUMMARY OF THE INVENTION

In order to overcome the deficiencies of the prior art, the present invention provides a kind of outdoor speaker to solve the technical questions that the sealing nature and the rain-proof performance in the current outdoor speakers are poor, the current outdoor speakers are easy to short-circuit and not easy to carry for larger, heavy bodies in the prior art.

The schemes of the present invention are as follows: a kind of outdoor speaker includes a shell and a horn assembly in the shell, the shell has a first surface and a second surface opposite the first surface, the first surface and the second surface are arranged two sides of the horn assembly, and a first mounting hole and a second mounting hole are provided thereon respectively, a first passive plate is mounted in the first mounting hole, and a second passive plate is mounted in the second mounting hole; a first protective shell covers the first surface and the first passive plate, a second protective shell covers the second surface and the second passive plate.

The first passive plate and the second passive plate are respectively arranged with a plenty of sound holes.

The first protective shell, the first surface and the first passive plate are enclosed to form one chamber, the second protective shell, the second surface and the second passive plate are enclosed to form the other chamber.

A centre of the first protective shell and that of the second protective shell are recessed toward the shell to form a first mounting slot and a second mounting slot, a first knob is mounted in the first mounting slot, a second knob is mounted in the second mounting slot.

The first mounting slot and the second mounting slot are respectively provided with a third mounting hole, a thread plug is contained in the third mounting hole, the first knob and the second knob are respectively provided with a thread rod which is inserted into the thread plug, resulting in that the first knob is rotatably mounted to the first protective shell, and the second knob is rotatably mounted to the second protective shell.

Preferably, the outdoor speaker further comprises a handle having a first end and a second end, which are respectively mounted on the first surface and the second surface.

The first end matches the first mounting slot and is placed therein, the second end matches the second mounting slot and is placed therein, the first end is provided with a first through hole, the second end is provided with a second through hole, the thread rod of the first knob is passed through the first through hole and inserted the internal thread plug, the thread rod of the second knob is passed through the second through hole and inserted the other internal thread plug, thereby being fixedly mounted the handle. And the first end and the second end can rotate around the thread rod so that the handle can rotate.

The horn assembly includes a magnet, a T iron, a washer, a sound ring, a basin frame, a paper basin and a dust cover. The magnet is a ring shape, and the T iron is inserted into a ring hole of the magnet, and the sound ring is arranged between the magnet and the T iron. The washer is also a ring shape, arranged on the upper part of the sound ring. The basin frame is arranged on the washer, a centre of the basin frame is provided with a third through hole, the sound ring is inserted into the third though hole, the paper basin is arranged on the basin frame, a centre of the paper basin is provided with a four through hole, a dust cover is disposed in the paper basin to cover the fourth through hole. The shell has a third surface, the third surface lies between the first surface and the second surface. A periphery edge of the basin frame is fixed on the third surface. The third surface is provided with a third mounting slot matching with the basin frame. A third protective shell is disposed on the third surface, the third protective shell is fixed on the third surface to cover the basin frame, the paper basin and the dust cover and the third surface.

A high pitch unit is mounted on the third surface, at a position close to the first passive plate.

The shell is also provided with a fourth surface opposite to the third surface, a speaker terminal and a switch button for the outdoor speaker are disposed on the fourth surface.

The outdoor speaker is also provided with a circuit board, electrically connected to the horn assembly, the terminal, and the switch button. The outdoor speaker is also provided with a power interface that is electrically connected to the circuit board and power the circuit board through an external power supply.

The beneficial effects according to the technical scheme in present invention are as follows: the outdoor speaker described in the present invention has good bass effect, good sealing, rain and dust prevention, suitable for use outdoor.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is a perspective view of the outdoor speaker according to one embodiment in the present invention.

FIG. 2 is a side view of the outdoor speaker according to one embodiment in the present invention.

FIG. 3 is a section view along A-A line in the FIG. 2.

FIG. 4 is a decomposition view of the outdoor speaker according to one embodiment in the present invention.

### DETAILED DESCRIPTION OF ILLUSTRATED EMBODIMENTS

In order to further clarify the technical scheme and the technical effect of the present invention, the present invention is further explained below in combination with specific embodiments below. It should be understood that the specific embodiments described herein are used only to interpret the present invention and are not used to define the present invention.

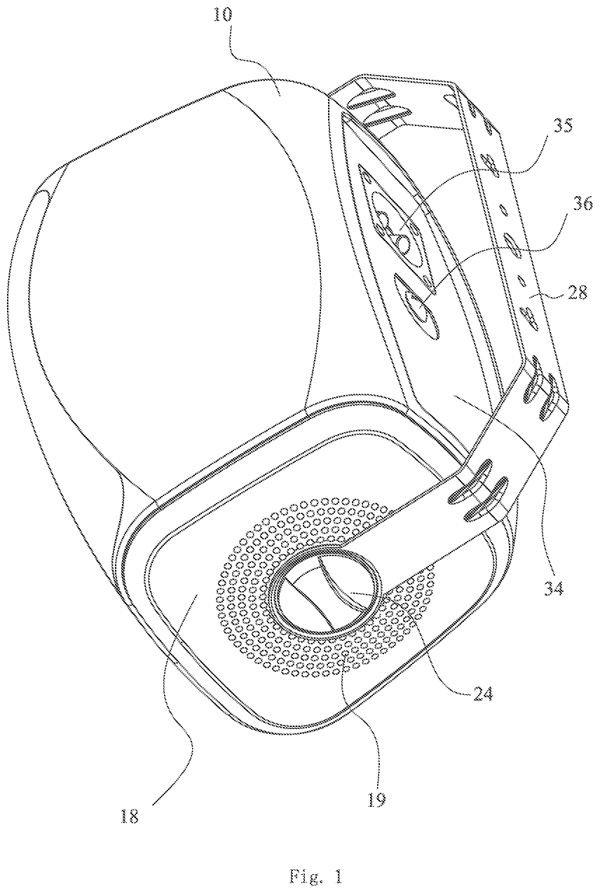

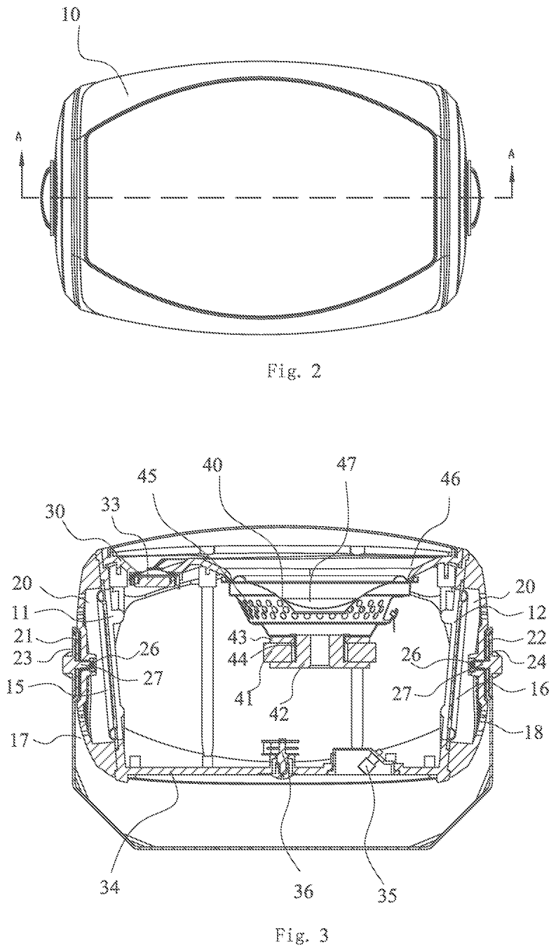

Referring to FIG. 1-4, an outdoor speaker includes a shell 10 and a horn assembly 40 in the shell 10. The shell 10 has a first surface 11 and a second surface 12 opposite the first surface 11, the first surface 11 and the second surface 12 are arranged two sides of the horn assembly 40, and a first mounting hole 13 and a second mounting hole 14 are provided thereon respectively, a first passive plate 15 is mounted in the first mounting hole 13, and a second passive plate 16 is mounted in the second mounting hole 14; a first protective shell 17 covers the first surface 11 and the first passive plate 15, a second protective shell 18 covers the second surface 12 and the second passive plate 16. The first passive plate 15 and the second passive plate 16 increase low frequency effect and protect the horn assembly 40, avoid water in air from entering the shell 10 to affect the effect of the outdoor speaker. The first protective shell 17 and the second protective shell 18 protect the first passive plate 15 and the second passive plate 16 respectively, and make the shape of the outdoor speaker beautiful.

The first passive plate 15 and the second passive plate 16 are respectively arranged with a plenty of sound holes 19. Low-frequency sound waves transmitted through the first passive plate 15 and the second passive plate 16 are further transmitted through the sound holes 19 and do not affect their sound effect.

The first protective shell 17, the first surface 11 and the first passive plate 15 are enclosed to form one chamber 20, the second protective shell 18, the second surface 12 and the second passive plate 16 are enclosed to form the other chamber 20. The chambers 20 are conducive to sound transmission.

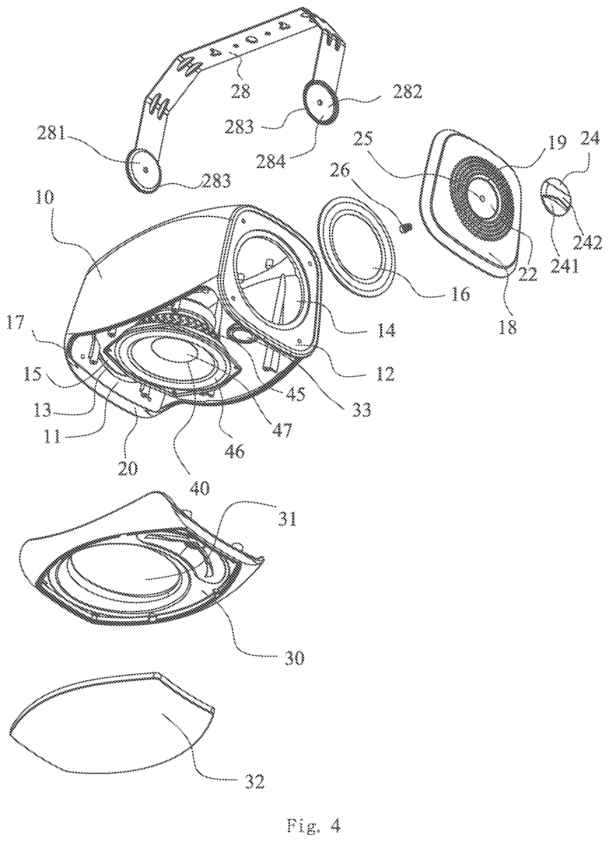

A centre of the first protective shell 17 and that of the second protective shell 18 are recessed toward the shell 10 to form a first mounting slot 21 and a second mounting slot 22, a first knob 23 is mounted in the first mounting slot 21, a second knob 24 is mounted in the second mounting slot 22. The first knob 23 and the second knob 24 are installed in the first mounting slot 21 and the second mounting slot 22 in a common way in the art, and it may be by clamp and slot connection, threaded connection, screw connection, or the like. Specifically, referring to FIG. 3, the first mounting slot 21 and the second mounting slot 22 are respectively provided with a third mounting hole 25, a thread plug 26 is contained in the third mounting hole 25, the first knob 23 and the second knob 24 are respectively provided with a thread rod 27 which is inserted into the thread plug 26, resulting in that the first knob 23 is rotatably mounted to the first protective shell 17, and the second knob 24 is rotatably mounted to the second protective shell 18.

Preferably, the outdoor speaker further comprises a handle 28 having a first end 281 and a second end 282, which are respectively mounted on the first surface 11 and the second surface 12, thereby facilitating to lift the outdoor speaker. Specifically, in the embodiment showing in FIGS. 3 and 4, the first end 281 matches the first mounting slot 21 and is placed therein, the second end 282 matches the second mounting slot 22 and is placed therein, the first end 281 is provided with a first through hole, the second end 282 is provided with a second through hole, the thread rod 27 of the first knob 23 is passed through the first through hole and inserted the internal thread plug 26, the thread rod 27 of the second knob 24 is passed through the second through hole and inserted the other internal thread plug 26, thereby being fixedly mounted the handle 28. And the first end 281 and the second end 282 can rotate around the thread rod 27 so that the handle 28 can rotate.

Preferably, a periphery 283 of the first end 281 and that of the second end 283 are protrude, the other parts 284 thereof are depressed to form a slot, both of the first knob 23 and the second knob 24 have a flat portion 241 and a bulge 242 raised upward from a center of the flat portion 241, the flat portion 241 is placed in the slot, the bulge 242 is convenient to rotate the knob 23, 24.

Referring to FIG. 3 and FIG. 4, the structure of the horn assembly 40 is common technology in the art. Specifically, the horn assembly 40 includes a magnet 41, a T iron 42, a washer 43, a sound ring 44, a basin frame 45, a paper basin 46 and a dust cover 47. The magnet 41 is a ring shape, and the T iron 42 is inserted into a ring hole of the magnet 41, and the sound ring 44 is arranged between the magnet 41 and the T iron 42. The washer 43 is also a ring shape, arranged on the upper part of the sound ring 44. The basin frame 45 is arranged on the washer 43, a centre of the basin frame 45 is provided with a third through hole, the sound ring 44 is inserted into the third though hole, the paper basin 46 is arranged on the basin frame 45, a centre of the paper basin 46 is provided with a four through hole 461, a dust cover 47 is disposed in the paper basin 46 to cover the fourth through hole 461. The shell 10 has a third surface 30, the third surface 30 lies between the first surface 11 and the second surface 12. A periphery edge of the basin frame 45 is fixed on the third surface 30. The third surface 30 is provided with a third mounting slot 31 matching with the basin frame 45. Specifically, the basin frame 45 is in the shape of a trumpet with a gradually enlarged caliber, the diameter of the third mounting slot 31 is also gradually expanded. A third protective shell 32 is disposed on the third surface 30, the third protective shell 32 is fixed on the third surface 30 to cover the basin frame 45, the paper basin 46 and the dust cover 47 and the third surface 30.

A high pitch unit 33 is mounted on the third surface 30, at a position close to the first passive plate 15. The structure and the principle of the high pitch unit 33 are common general knowledge that should be known by those skilled in the art, and will not be repeated in the application.

The shell 10 is also provided with a fourth surface 34 opposite to the third surface 30, a speaker terminal 35 and a switch button 36 for the outdoor speaker are disposed on the fourth surface 34.

The outdoor speaker is also provided with a circuit board, electrically connected to the horn assembly 40, the terminal 35, and the switch button 36. The outdoor speaker is also provided with a power interface that is electrically connected to the circuit board and power the circuit board through an external power supply.

The above contents are further detailed description of the present invention with reference to preferred embodiments, and it cannot be determined that the embodiments of the present invention are only limited to these descriptions. For a person of ordinary skill in the art to which the present invention belongs, on the premise of keeping the conception of the present invention, the architecture form thereof can be flexible and varied, and a series of products can be derived. It is only a few simple deductions or replacements that should be considered as belonging to the scope of the invention as filed.

What is claimed is:

1. An outdoor speaker, comprising a shell and a horn assembly in said shell, wherein said shell has a first surface and a second surface opposite said first surface, said first surface and said second surface are arranged two sides of said horn assembly, a first mounting hole and a second mounting hole are provided thereon respectively; a first passive plate is mounted in said first mounting hole, and a second passive plate is mounted in said second mounting hole; a first protective shell covers said first surface and said first passive plate, a second protective shell covers said second surface and said second passive plate.

2. The outdoor speaker according to claim 1, wherein said first passive plate and said second passive plate are respectively arranged with a plenty of sound holes.

3. The outdoor speaker according to claim 1, wherein said first protective shell, said first surface and said first passive plate are enclosed to form one chamber, said second protective shell, said second surface and said second passive plate are enclosed to form the other chamber.

4. The outdoor speaker according to claim 1, wherein a centre of said first protective shell and that of said second protective shell are recessed toward said shell to form a first mounting slot and a second mounting slot, a first knob is mounted in said first mounting slot, a second knob is mounted in said second mounting slot.

5. The outdoor speaker according to claim 4, wherein said first mounting slot and said second mounting slot are respectively provided with a third mounting hole, a thread plug is contained in said third mounting hole, said first knob and said second knob are respectively provided with a thread rod which is inserted into said thread plug, resulting in that said first knob is rotatably mounted to said first protective shell, and said second knob is rotatably mounted to said second protective shell.

6. The outdoor speaker according to claim 1, wherein also comprising a handle having a first end and a second end, which are respectively mounted on said first surface and said second surface.

7. The outdoor speaker according to claim 1, wherein said first end matches said first mounting slot and is placed therein, said second end matches said second mounting slot and is placed therein, said first end is provided with a first through hole, said second end is provided with a second through hole, said thread rod of said first knob is passed through said first through hole and inserted said internal thread plug, said thread rod of said second knob is passed through said second through hole and inserted the other internal thread plug, thereby being fixedly mounted said handle; and said first end and said second end can rotate around said thread rod so that said handle can rotate.

8. The outdoor speaker according to claim 1, wherein said horn assembly includes a magnet, a T iron, a washer, a sound ring, a basin frame, a paper basin and a dust cover. said magnet is a ring shape, and said T iron is inserted into a ring hole of said magnet, and said sound ring is arranged between said magnet and said T iron; said washer is also a ring shape, arranged on said upper part of said sound ring; said basin frame is arranged on said washer, a centre of said basin frame is provided with a third through hole, said sound ring is inserted into said third though hole, said paper basin is arranged on said basin frame, a centre of said paper basin is provided with a four through hole, a dust cover is disposed in said paper basin to cover said fourth through hole; said shell has a third surface, said third surface lies between said first surface and said second surface; a periphery edge of said basin frame is fixed on said third surface; said third surface is provided with a third mounting slot matching with said basin frame; a third protective shell is disposed on said third surface, said third protective shell is fixed on said third surface to cover said basin frame, said paper basin and said dust cover and said third surface.

9. The outdoor speaker according to claim 1, wherein a high pitch unit is mounted on said third surface, at a position close to said first passive plate.

10. The outdoor speaker according to claim 8, wherein said shell is also provided with a fourth surface opposite to said third surface, a speaker terminal and a switch button for said outdoor speaker are disposed on said fourth surface.
